(19) United States
(12) Patent Application Publication
(10) Pub. No.: US 2007/0111094 A1
(43) Pub. Date: May 17, 2007

(54) Synthesis of intermetallic negative electrodes for lithium cells and batteries

(76) Inventors: Michael M. Thackeray, Naperville, IL (US); Christopher S. Johnson, Naperville, IL (US)

Correspondence Address: HARRY M. LEVY;OLSON & HIERL, LTD., 20 North Wacker, 36th Floor, CHICAGO, IL, 60606-4401, US

(21) Appl. No.: 09/943,966

(22) Filed: Aug. 31, 2001

(51) Int. Cl. H01M 4/38; C22B 3/00

(52) U.S. Cl. 429/218.1; 423/1

(57) ABSTRACT

A method of making an intermetallic negative electrode for an electrochemical cell. One or more metal salts is dissolved in an organic solvent forming a solution to which is added a metal reducing agent to form an intermetallic compound. Thereafter, the intermetallic compound precipitates and is separated and formed into an electrode. The electrodes are useful in electrochemical cells and batteries.

### CONTRACTUAL ORIGIN OF THE INVENTION

The United States Government has rights in this invention pursuant to Contract No. W-31-109-ENG-38 between the U.S. Department of Energy (DOE) and The University of Chicago representing Argonne National Laboratory.

### FIELD OF THE INVENTION

The present invention relates to rechargeable lithium cells commonly referred to as lithium-ion cells (and batteries) for powering devices such as cellular phones, laptop and hand-held computers and camcorders. The present invention is also used for larger applications such as stand-by energy storage, electric and hybrid-electric vehicles.

### BACKGROUND OF THE INVENTION

In rechargeable lithium-ion battery technology, the most common lithium-ion cell has the configuration LiₓC/electrolyte/Li₁₋ₓCoO₂. During charge and discharge lithium ions are shuttled electrochemically between two host electrode structures that consist of a carbonaceous (typically graphitic) LiₓC anode and a layered Li₁₋ₓCoO₂ cathode. These cells are inherently unsafe, particularly if heated in a charged state or if they are overcharged without protective electronic circuitry. Lithiated graphite electrodes operate at a potential very close to that of metallic lithium, and therefore are extremely reactive. One of the methods of reducing the activity of the anode (negative electrode) of lithium-ion cells is to use a metal or an intermetallic compound that reacts with lithium a few hundred millivolts above the potential of metallic lithium, such as Al, Sn and Sb or FeSn₂, SnSb, Cu₆Sn₅, Cu₂Sb and InSb. The intermetallic compounds Cu₆Sn₅, Cu₂Sb and InSb are of particular interest because it was recently discovered that 1) they operate as electrodes in electrochemical lithium cells by a mechanism by which lithium can be inserted into a host metal array (for example, Sn or Sb) with the concomitant extrusion of a metal (for example, Cu or In), and 2) that the reactions are reversible. In order to get acceptable capacity from intermetallic electrodes it has been necessary to prepare the powders with a small particle/grain size and an acceptably high surface area to provide a sufficiently high capacity. Common methods that have been used in the past to synthesize intermetallic electrodes are high-temperature melting/annealing followed by pulverization, high-energy ball-milling of the metal elements, or electrochemical co-deposition methods. This invention relates to a new, alternative method for preparing electrochemically active intermetallic electrode powders for lithium batteries at room temperature by a chemical solution process.

### SUMMARY OF THE INVENTION

This invention relates to a chemical method for synthesizing and processing intermetallic negative electrodes for electrochemical lithium cells and batteries. More specifically, it relates to a room-temperature solution route in which one or more metal salts are dissolved in an organic solvent followed by the addition of a metal reducing agent, such as zinc, by filtration of the solid intermetallic product and by removal of the soluble by-products to leave crystalline and electrochemically active intermetallic metal electrode powders.

In one embodiment of the invention, the intermetallic electrode can contain an excess of one or more of metal element components within the powdered electrode matrix. In a second embodiment of the invention, the powders can be synthesized in the presence of electrochemically inactive fillers to act as grain growth inhibitors, porosity regulators or binders, and electronically conducting additives or substrates such as other metals, hard carbons, carbon fibers, or graphites to improve the performance of the lithium cells and batteries. In a further embodiment, the invention extends to include electrochemical cells and batteries containing such negative intermetallic electrodes when synthesized according to the method of the invention.

Metal or intermetallic compounds that react with lithium are well known as electrodes for lithium batteries. These compounds have, in general, been prepared in the past by solid state reactions between the metal elements at temperatures either close to, or slightly above, the melting points of the elements, as described, for example, by Wang, Raistrick & Huggins in the Journal of the Electrochemical Society, Vol. 133, pg. 457 (1986). Alternatively, they have been prepared by high-energy ball-milling at lower temperature, as described, for example, by O. Mao, R. A. Dunlap & J. R. Dahn in the Journal of the Electrochemical Society, Vol. 146, pg. 405 (1999). It has been generally found that electrodes prepared and annealed at high temperature and then rapidly quenched to room temperature are highly crystalline and do not provide as good an electrochemical capacity as intermetallic electrodes that are prepared by high-energy ballmilling and which are characterized by higher surface area, crystal inhomogeneities and defects. High surface area electrodes can also be prepared by electrochemical co-deposition techniques as disclosed by Besenhard, Yang and Winter in J. Power Sources, Vol. 68, pg. 87 (1997). A disadvantage of high-temperature, high-energy ball-billing and electrochemical co-deposition techniques is that they all require additional electrical energy to produce electrode particles of the required dimension and electrochemical activity. Moreover, the additional electrical energy required in these techniques provides an additional and unwanted cost burden on electrode fabrication, and hence on the overall cost cell and battery products. In particular, when intermetallic electrodes in which the structure of the parent compound plays an important role are prepared, it is important that the synthesis method can yield products in which crystal in homogeneities and defects can be controlled. This invention relates to such a method which is both simple and cost-effective; it involves the chemical reduction of metal salts at temperatures close to room temperature, and thus eliminates the need for additional electrical energy required by high-temperature methods, high-energy ball-milling and electrochemical co-deposition.

The principles of this invention are described with respect to three electrode systems: 1) copper-tin, Cu₆Sn₅, and substituted compounds Cu₆₋ₓMₓSn₅ (M=Fe, Ni, x=1), 2) indium antimonide, InSb, and 3) copper antimonide, Cu₂Sb.

### BRIEF DESCRIPTION OF THE DRAWINGS

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

FIG. 1(a)-(e) are representations of the powder X-ray diffraction patterns (CuKα radiation) of the intermetallic electrode products, synthesized in accordance with the invention, of a) Cu₆Sn₅, b) Cu₅NiSn₅, c) Cu₅FeSn₅, d) InSb and e) Cu₂Sb;

FIG. 2(a)-(e) are graphical representations of the discharge/charge voltage profiles for the first ten cycles of the following cells in which the intermetallic electrodes were synthesized according to the invention, a) Li/Cu₆Sn₅, b) Li/Cu₅NiSn₅, c) Li/Cu₅FeSn₅, d) Li/InSb and e) Li/Cu₂Sb;

FIG. 3 is a graphical representation of the capacity versus cycle number for the first ten cycles of the following cells a) Li/Cu₆Sn₅, b) Li/Cu₅NiSn₅, c) Li/Cu₅FeSn₅, d) Li/InSb and e) Li/Cu₂Sb in which the intermetallic electrodes were synthesized according to the invention;

FIG. 4 depicts a schematic representation of an electrochemical cell; and

FIG. 5 depicts a schematic representation of a battery consisting of a plurality of cells connected electrically in series and in parallel.

### DESCRIPTION OF THE PREFERRED EMBODIMENTS

This invention relates to a chemical method for synthesizing and processing intermetallic electrodes for lithium cells and batteries. More specifically, it relates to a solution route that involves the reduction of one or more soluble metal salts, preferably two or more soluble metal salts, by a metal reducing agent such as magnesium or zinc, to produce crystalline and electrochemically active intermetallic powders. The salts are preferably metal chlorides. A modification of this method has been used in the past to synthesize the III-V semiconductor InAs as disclosed by Li, Duan, Qian, Yang, Ji and Li in the Journal of the American Chemical Society, Volume 119, pg. 7869 (1997). However, although the use of zinc as a reducing agent for transition metals is well known as described by Brown and Le May, Jr, in Chemistry: The Central Science, Prentice Hall (1977), such a procedure has not, to the best of our knowledge, been exploited advantageously for fabricating electrochemically active electrodes for rechargeable lithium batteries. Moreover, by using this technique for improving battery performance, the electrode powders can be synthesized with an excess of one or more of the metal components in the structure or in the presence of electrochemically inactive fillers to act as grain growth inhibitors, porosity regulators or polymeric binders, and electronically conducting additives or substrates such as other metals, hard carbons, carbon fibers, or graphites.

The synthesis procedure of this invention differs from standard metallurgical processing routes that are typically used to make intermetallic compounds, such as ball milling, high temperature melt/anneal reactions or electrochemical co-deposition. The compounds produced by the method of this invention are electrochemically active and are used as the negative electrode (anode) of a lithium cell or battery. By way of example, the negative electrodes can have structures related to those of NiAs, Ni₂In, ZnS (zinc-blende) and Cu₂Sb, and contain elements such as Cu and Sn, as in Cu₆Sn₅ (intermediate NiAs/Ni₂In-type structure), or In and Sb as in InSb, or Cu and Sb as in Cu₂Sb. Other elements may be incorporated into the intermetallic structures by substitution. For example, in the copper-tin system Cu₆₋ₓMₓSn₅ (0<x<˜3), the M substituent can be one or more first row transition metal elements, such as Mn, Fe, Co, Ni and Zn. The synthesis method has several advantages over the more conventional ball-milling method, the high-temperature melt/anneal technique and electrochemical co-deposition because the reaction is solution based and starts from molecular precursors; moreover, with the solution-based technique, metal substitutions can be easily made, resulting in essentially phase-pure products. It has also been established that the synthesis technique of the invention allows morphological control of the intermetallic particles that can be achieved at a micron and sub-micron level. The resulting intermetallic powders can be easily laminated into working electrodes for lithium cells and batteries.

According to the invention, the synthesis method involves first, the dissolution of one or more appropriate metal salts, preferably metal chlorides, in organic solvents such as ethylene glycol, ethanol, glycerol and/or xylenes, to form a solution, followed by the addition of a metal such as magnesium or zinc as reducing agent to precipitate the intermetallic product. Thereafter, the precipitated product is removed from the solution and formed into an electrode using well known techniques. The metal chlorides are preferably selected from those of the transition metal elements and/or the group IIIa, IVa and Va elements, and more preferably from Al, In, Sn, Sb, Cr, Mn, Fe, Co, Ni, Cu and Zn. The process can be used for small-scale synthesis, typically 5-10 gm, or large-scale synthesis, for example, up to a batch size of 1 kg, or larger.

The principles of this invention are described with respect to the synthesis of InSb, Cu₆Sn₅ and substituted compounds, and Cu₂Sb. The reactions for the formation of InSb from indium trichloride and antimony trichloride, Cu₆Sn₅ from copper dichloride and tin dichloride, and Cu₂Sb from copper dichloride and antimony trichloride, are as follows:
3 Zn (s)+InCl₃ (soln.)+SbCl₃ (soln.)→InSb (s)+3 ZnCl₂ (soln.),
11 Zn (s)+6 CuCl₂ (soln.)+5 SnCl₂ (soln.)→Cu₆Sn₅ (s)+11 ZnCl₂ (soln.), and
7 Zn (s)+4 CuCl₂ (soln.)+2 SbCl₃ (soln.)→2 Cu₂Sb (s)+7 ZnCl₂ (soln.)

In a typical synthesis of an intermetallic electrode that contains two or more metal elements, stoichiometric amounts of the appropriate metal chloride salts are dissolved in ethylene glycol, stirred for ½ to 10 h, preferably 1-3 h, at approximately 0° C. during the addition of zinc metal powder, and then stirred at room temperature for another 2-24 h, preferably 6-16 h, and more preferably 2-4 h. Batch ratios that are typically used are: 1 gram of chloride salt and zinc powder (i.e., the combined amounts required by the stoichiometric reaction) to 10 milliliters of solvent. The solid product is isolated by vacuum filtration, rinsed and washed with methanol to remove the soluble by-product, ZnCl₂. In order to complete the reaction and to ensure a fully reduced product, it may be necessary to perform a low temperature anneal step, typically at 150-400° C., preferably 250-350° C., in an inert atmosphere (i.e. argon, helium or nitrogen), or more preferably, in a reducing atmosphere such as regeneration gas (i.e. He/4% H₂). In instances where substitutions are required, for example, in Cu₆₋ₓMₓSn₅ compounds, the substituted metal M is added as a soluble salt, preferably as a chloride, to the initial solution in the amount required by the stoichiometry of the final product.

In one embodiment of the invention, the composition of the intermetallic electrode can be selected such that it is fabricated with one or more additional metal components, i.e., more than the amount required by the stoichiometry of the pure intermetallic compound. For example, a copper-tin (Cu₆Sn₅) electrode reacts in a lithium cell in a series of reactions in which copper is displaced from a framework of Sn atoms. Under ideal conditions, the first reaction is believed to take place predominantly by a topotactic process, whereby lithium is inserted into the NiAs-type structure to yield a lithiated zinc-blende-type structure resembling Li₂CuSn, with the concomitant extrusion of a small amount of copper; thereafter, further Cu is displaced from an Sn framework according to the generalized ideal reactions:
10 Li+Cu₆Sn₅←→5 “Li₂CuSn”+Cu
x Li+“Li₂CuSn”←→Li₂₊ₓCu₁₋ₓSn+x Cu (0<x<1)
(2.4−x) Li+Li₂₊ₓCu₁₋ₓSn←→Li_{4.4}Sn+(1−x) Cu

Although these reactions are electrochemically reversible, some of the extruded Cu particles can lose electrical contact with the parent electrode structure, which compromises the coulombic efficiency and reversibility of the electrochemical reaction. Therefore, it is believed that the coulombic efficiency and reversibility of the reaction and hence the cycle life of the cell can be enhanced if the initial parent electrode is fabricated with additional copper. In this respect, the synthesis of electrodes can be adapted to yield modified electrode compositions, such as Cu₆Sn₅•δCu in which the additional δCu is present in finely divided form and in intimate contact with the Cu₆Sn₅ particles. In practice, the value of δ can vary, but is selected preferably such that the additional copper content in the intermetallic electrode is less than 50 percent, and more preferably, less than 20 percent of the total mass of the electrode.

By analogy, for InSb and Cu₂Sb electrodes, the overall reactions for the extrusion of In and Cu from an essentially invariant face-centered-cubic Sb array of the parent structure are:
3 Li+InSb+←→Li₃Sb+In
3 Li+Cu₂Sb←→Li₃Sb+2 Cu

Therefore, for InSb and Cu₂Sb electrodes, it is advantageous to add additional In and Cu, respectively, to the initial electrodes, preferably less than 20 percent by mass, to enhance the coulombic efficiency and rechargeability of the electrodes in a lithium cell.

In the second embodiment of the invention, the synthesis of the intermetallic electrodes can be carried out in the presence of electrochemically inactive fillers to act as grain growth inhibitors or porosity regulators, such as 1) an inert metal oxide, for example Al₂O₃ or MgO, 2) polymeric binders, for example, teflon (PTFE) or polyvinylidene fluoride (PVDF) and 3) electronically conducting additives or substrates such as other metals, hard carbons, carbon fibers, or graphites.

The following examples describe the principles of the invention as contemplated by the inventors, but they are not to be construed as limiting examples.

### EXAMPLE 1

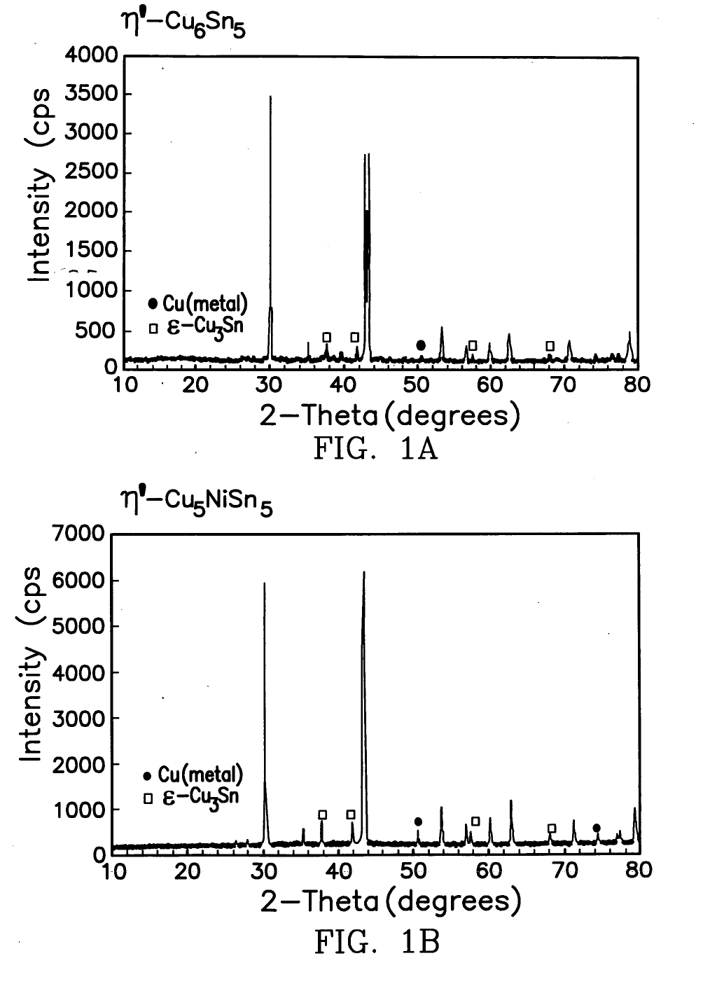

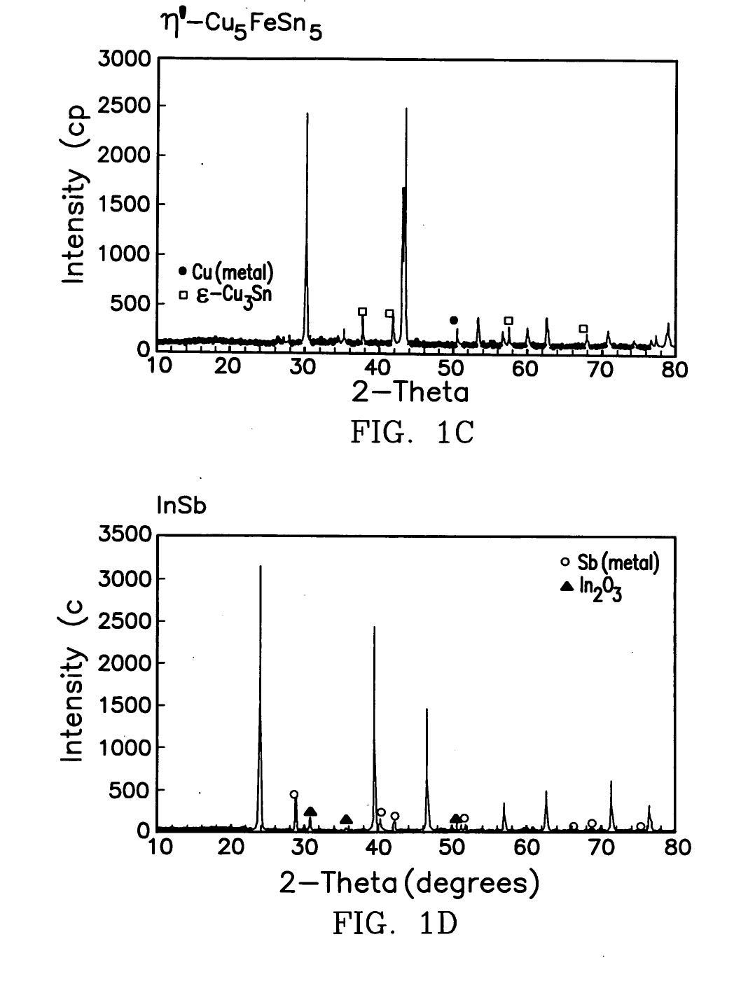

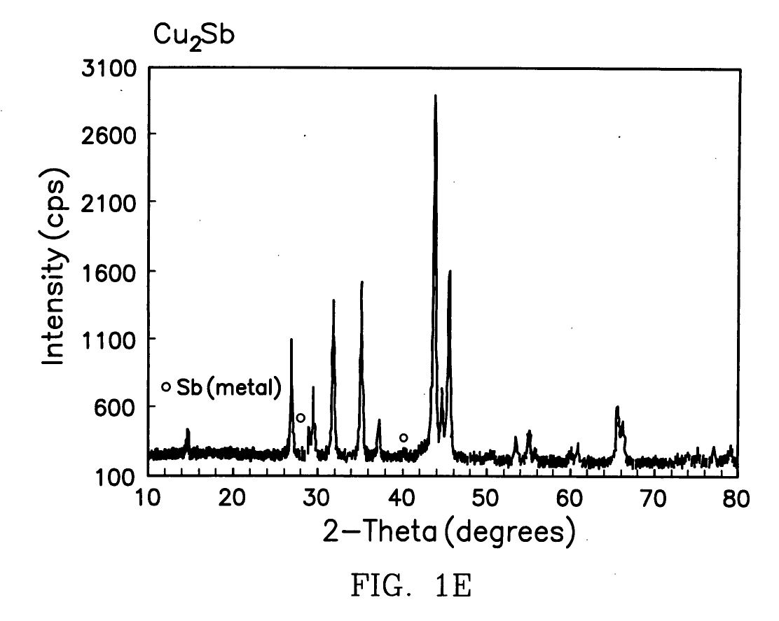

For the synthesis of Cu₆Sn₅, Cu₅NiSn₅, Cu₅FeSn₅, InSb and Cu₂Sb, stoichiometric amounts of the metal chloride salts totaling 1 gram were dissolved in 10 ml ethylene glycol, stirred for 3 h at 0° C. during the addition of zinc metal powder, and then stirred at room temperature for another 16 hours. The solid products were isolated by vacuum filtration, rinsed and washed with methanol to remove the soluble by-product, ZnCl₂. The products were dried at room temperature under vacuum. The Cu₆Sn₅, Cu₅NiSn₅, Cu₅FeSn₅, InSb powders were annealed under argon gas at 400° C., whereas the Cu₂Sb powder was used, as is, after vacuum drying at room-temperature. The X-ray diffraction patterns (CuKa radiation) of the five intermetallic products, namely, Cu₆Sn₅, Cu₅NiSn₅, Cu₅FeSn₅, InSb and Cu₂Sb are shown in FIG. 1 (a-e). As can be seen from the figures, the X-ray diffraction patterns of the Cu₆₋ₓMₓSn₅ products show minor concentrations of Cu₃Sn and Cu by-products, while the InSb sample shows minor concentrations of Sb and In₂O₃ by-products; a small amount of metallic Sb is observed in the Cu₂Sb product. It is believed that annealing in a reducing atmosphere, for example 4 volume percent hydrogen in helium, removes surface contaminants, such as surface oxides.

### EXAMPLE 2

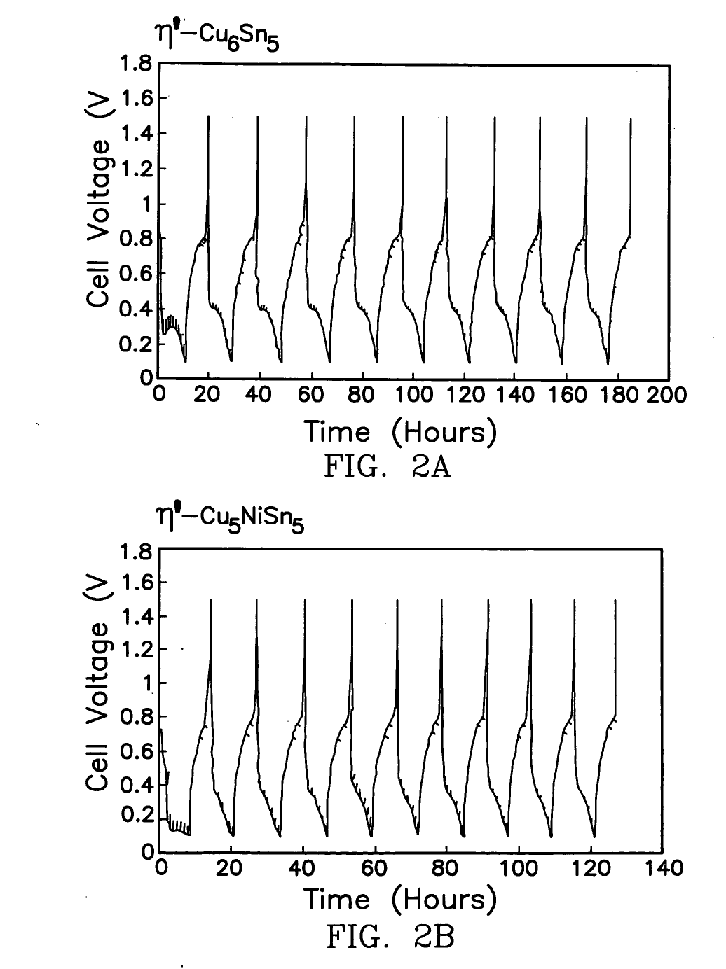

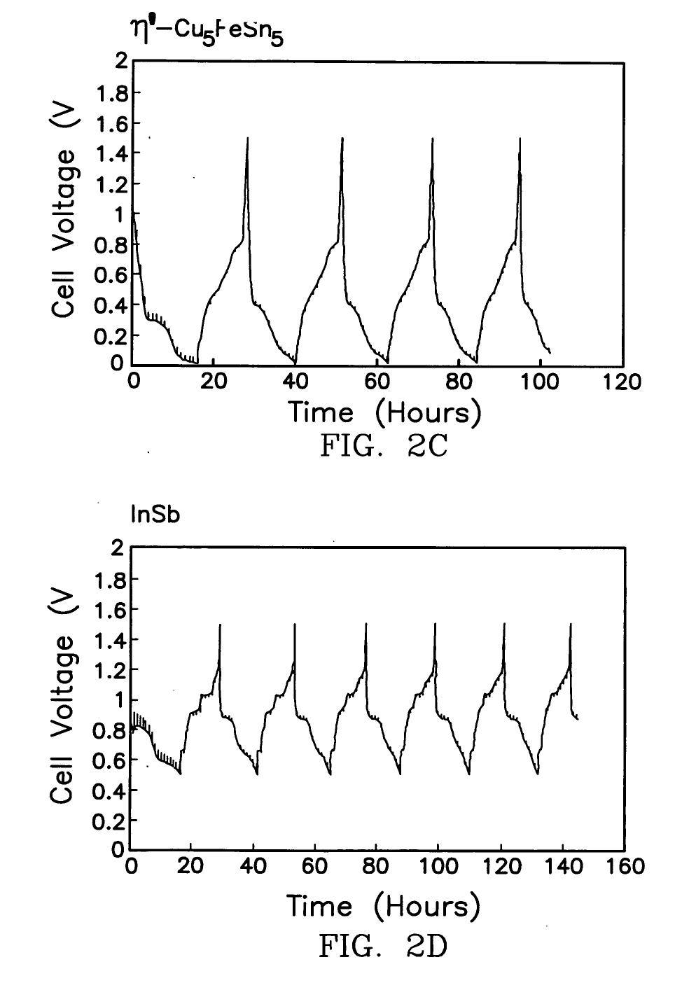

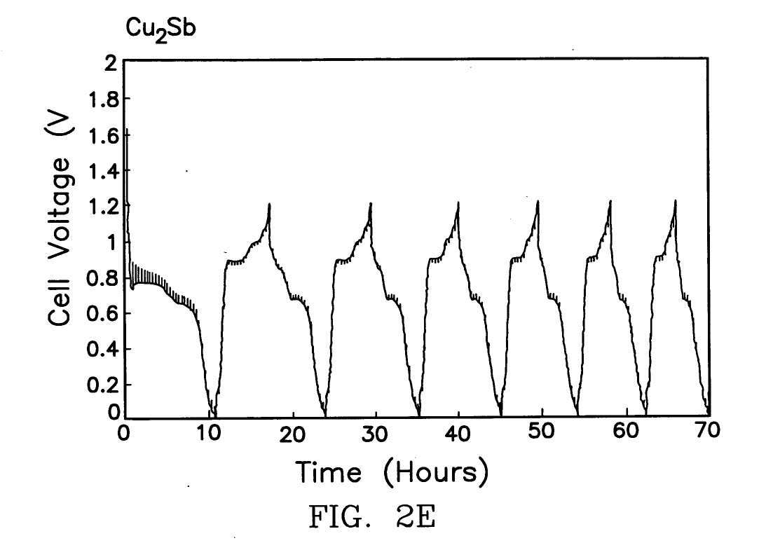

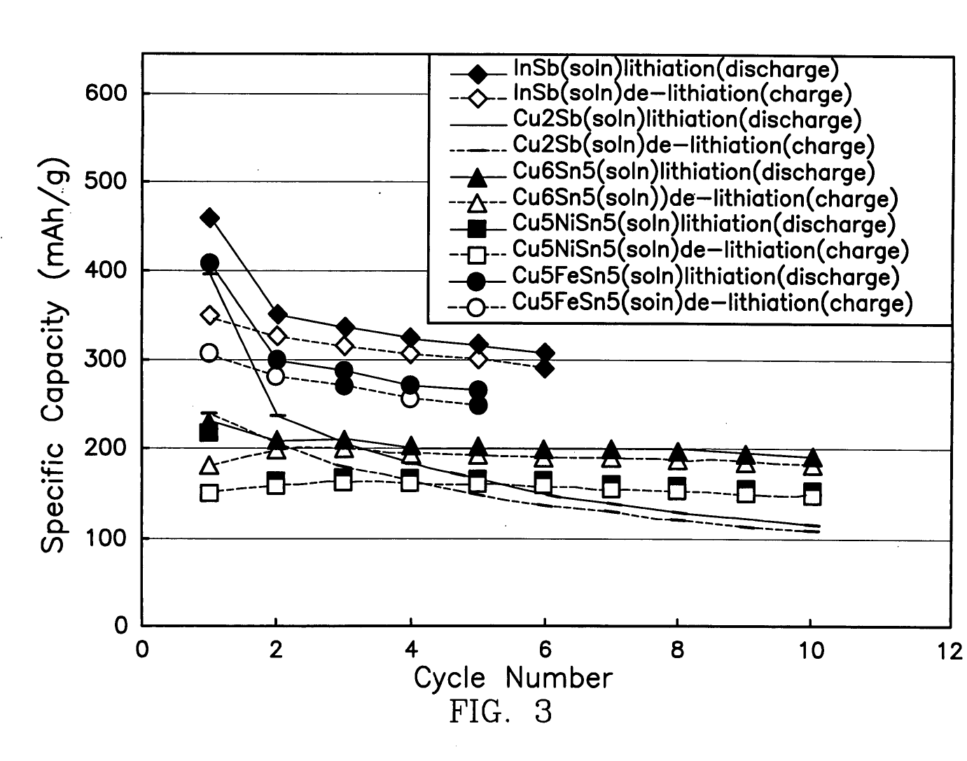

The electrochemical properties of the intermetallic Cu₆Sn₅, Cu₅NiSn₅, Cu₅FeSn₅, InSb and Cu₂Sb products were evaluated as electrodes in lithium cells having the following configuration Li/EC:DEC (1:1), 1 M LiPF₆/intermetallic electrode. Each electrode consisted of 84% intermetallic compound, 8% carbon, 8% PVDF binder. Cells were charged and discharged at constant current at 0.2 mA/cm². The data in FIGS. 2 and 3 show the electrochemical performance of the electrodes when synthesized by the method of this invention; the voltage profiles of the various cells in FIG. 2 are consistent with those of Cu₆Sn₅, Cu₅NiSn₅, Cu₅FeSn₅, InSb and Cu₂Sb electrodes when synthesized by high-energy ball-milling techniques.

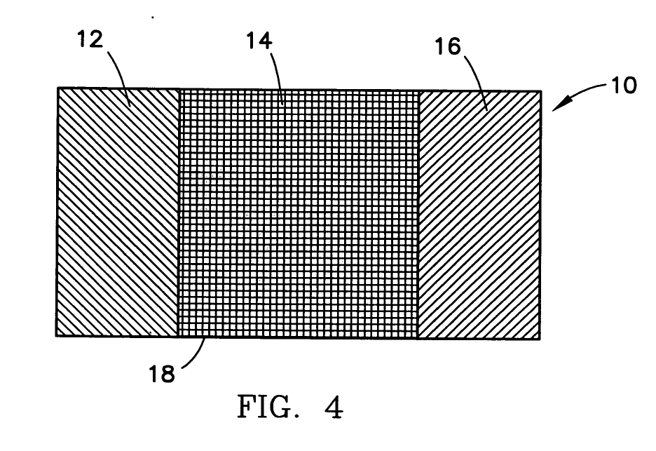

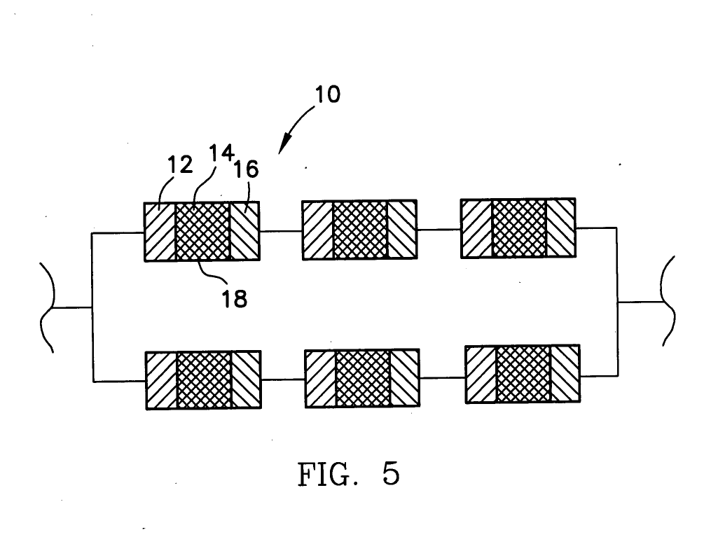

This invention extends to include non-aqueous electrochemical lithium cells and batteries containing such intermetallic electrodes when synthesized according to the said method. A representation of such a cell is shown schematically in FIG. 4, the cell represented by the numeral 10 having a negative electrode 12 separated from a positive electrode 16 by an electrolyte 14, all contained in an insulating housing 18 with suitable terminals (not shown) being provided in electronic contact with the negative electrode 12 and the positive electrode 16. Binders and other materials normally associated with both the electrolyte and the negative and positive electrodes are well known in the art and are not described herein, but are included as is understood by those of ordinary skill in this art. FIG. 5 shows a schematic illustration of one example of a battery in which two strings of electrochemical lithium cells, described above, are arranged in parallel, each string comprising three cells arranged in series.

While there has been disclosed what is considered to be the preferred embodiment of the present invention, it is understood that various changes in the details may be made without departing from the spirit, or sacrificing any of the advantages of the present invention.

The embodiments of the invention in which an exclusive property or privilege is claimed are defined as follows:

1. A method for synthesizing an intermetallic negative electrode for an electrochemical cell comprising: dissolving one or more metal salts in an organic solvent forming a solution; adding a metal reducing agent to the solution to form an intermetallic compound; precipitating the intermetallic compound; separating the precipitate from the solution and forming the precipitate into an electrode.

2. A method according to claim 1, in which two or more metal salts are used.

3. A method according to claim 1, in which the metal salts are metal chlorides.

4. A method according to claim 3, in which the metal chlorides are selected from the transition metal elements and one or more of the group IIIa, IVa and Va elements.

5. A method according to claim 3, in which the metal chlorides are two or more of Al, In, Sn, Sb, Cr, Mn, Fe, Co, Ni, Cu and Zn.

6. A method according to claim 1, in which the organic solvent is selected from one or more of ethylene glycol, ethanol, glycerol and xylenes.

7. A method according to claim 1, in which the reducing metal is Zn or Mg.

8. A method according to claim 1, in which the intermetallic electrode contains an excess of one or more of metal element components within the electrode matrix.

9. A method according to claim 1, in which stoichiometric amounts of metal salts are dissolved in an organic solvent, stirred for ½ to 10 h at approximately 0° C. during the addition of a reducing metal powder, and then stirred at room temperature for another 2 to 24 h.

10. A method according to claim 9, in which the solid intermetallic product is annealed in an inert atmosphere or in a reducing atmosphere at 150-400° C.

11. A method according to claim 1, and further comprising adding one or more grain growth inhibitors, porosity regulators, polymeric binders and electronically conducting additives.

12. An electrochemical cell containing an intermetallic negative electrode, a non-aqueous electrolyte and a positive electrode, the intermetallic electrode being made in accordance with the method of claim 1.

13. A battery consisting of a plurality of cells of claim 12, said cells being arranged in series and/or in parallel.
